(19) United States
(12) Patent Application Publication
(10) Pub. No.: US 2005/0035511 A1
(43) Pub. Date: Feb. 17, 2005

(54) Anti-vibration element

(75) Inventors: Sebastian Friedrich, Waiblingen (DE); Klaus-Martin Uhl, Baltmannsweiler (DE)

Correspondence Address: ROBERT W. BECKER & ASSOCIATES, 707 Highway 66 East, Suite B, Tijeras, NM, 87059, US

(73) Assignee: Andreas Stihl AG & Co., KG, Waiblingen (DE)

(21) Appl. No.: 10/913,040

(22) Filed: Aug. 5, 2004

(30) Foreign Application Priority Data
Aug. 5, 2003 (DE) 103 35 720.3

(51) Int. Cl. F16F 7/00

(52) U.S. Cl. 267/141.2

(57) ABSTRACT

An anti-vibration element for disposition between two components of a manually operated implement, especially a parting-off grinder, a chain saw, a suction/blower device, or the like, is provided. The anti-vibration element includes a spiral spring that is guided so as to be elastic in all spatial directions. In addition to the spiral spring, a rubber elastic damping element is provided that, relative to the plane of winding of the spiral spring, is more rigid in the axial direction than in the radial direction.

### BACKGROUND OF THE INVENTION

The invention relates to an anti-vibration element between two components of a manually operated implement, in particular a parting-off grinder, a chain saw, a suction device/blower or the like.

So-called anti-vibration elements by means of which two distinct components are separated in order to insulate vibrations are widely used in manually operated implement. For example, a number of anti-vibration elements may be positioned between a handle component and a component connected to the engine. Vibrations which are excited by the drive engine of the implement or by a driven implement can thus be kept away from the handle component within certain limits. Good vibration insulation requires a non-rigid design of these anti-vibration elements. The corresponding non-rigid connection between the handle component and the remainder of the implement may, however, have an disadvantageous effect on the operating accuracy of the implement.

It has been shown that, particularly in single cylinder drive engines in an implement, vibration excitation occurs primarily in one principal direction which may differ from the direction of the manual force applied at the handle component. With suitably designed and positioned anti-vibration elements it is possible to set a desired defined level of non-rigidity in the principal direction of excitation, while the arrangement is designed to be correspondingly more rigid in the direction of the primarily occurring manual forces applied in the operation of the implement.

An anti-vibration element in which a flat spiral spring is positioned between an outer ring and an inner sleeve is known from DE 199 43 628 A1. The flat spiral spring is wound in a spiral in a plane of winding. The spring rigidity of the flat spiral spring in the radial direction differs from that in the axial direction in relation to the plane of winding. It has, however, been shown that it is impossible to set a sufficiently large difference between the spring rigidities in these two directions with reasonable effort. When the flat spiral spring is deflected radially, the spring wire or sheet is essentially subject to bending stress, while in the case of axial deflection it is essentially subject to torsional stress. With simple cross-sectional shapes, however, any change in flexional strength due to a change in the cross-section of the spring also leads to an undesired change in torsional strength. A design in which the arrangement is non-rigid in one spatial direction and rigid in the other is possible only to a limited extent.

The essentially linear spring characteristic of a flat spiral spring may lead to an excessive spring stroke under operating load in the case of the non-rigid setting required for vibration damping.

The object of the invention is to provide an anti-vibration element which can be better adapted to loads from different directions.

### SUMMARY OF THE INVENTION

To this end an anti-vibration element is proposed having a flat spiral spring which is mounted elastically in all spatial directions, a rubber elastic damping element being provided in addition to the flat spiral spring. In this arrangement, the rubber elastic damping element is more rigid in the axial direction than in the radial direction in relation to the plane of winding of the flat spiral spring. Particularly in a design in which the rubber elastic damping element is more rigid in the axial direction and less rigid in the radial direction than the flat spiral spring, it is possible to set a good, non-rigid damping spring characteristic in the radial direction, while producing comparatively rigid suspension perpendicular thereto in the radial direction. In a corresponding arrangement of anti-vibration elements of this type, the excitation of vibrations in a principal direction of excitation can effectively be decoupled by a handle, for example. Perpendicular thereto this produces a sufficiently rigid connection for the handle, as a result of which the implement can be operated accurately in this direction.

It has been shown that rubber elastic damping elements under static load are comparatively non-rigid. Dynamic hardening takes place under a high frequency vibrating load, dynamic rigidity being four times the static rigidity under certain circumstances within the standard frequency spectrum for known implements. In the arrangement disclosed in the invention, however, it is possible to design the rubber elastic damping element to be so non-rigid in the radial direction that dynamic stiffening plays only a subordinate role. The damping function is assumed primarily by the flat spiral spring. In this direction it is desirable to have an anti-vibration element of non-rigid design without reducing the operating accuracy of the implement. Perpendicular to the plane of winding of the flat spiral spring, i.e. in the axial direction, the rubber elastic damping element assumes a significant proportion of the work of a rigid elastic mount, while the elastic suspension of the flat spiral spring which is non-rigid in this direction is of subordinate importance. The problem of the dynamic hardening of the rubber elastic damper is almost insignificant in the arrangement disclosed in the invention since in an appropriate arrangement only low dynamic excitement is expected in this direction.

In an advantageous development the rubber elastic damping element lies in particular pre-stressed on a bearing surface which runs approximately in the radial direction. In this arrangement the rubber elastic damping element can be moved essentially freely in the radial direction. The fact that the damping element is supported on the bearing surface means on the one hand that the elastic spring and damping properties in the axial direction are determined essentially by the rubber elastic material. It is possible to set a rigid damping characteristic in this direction in the desired manner. On the other hand, the fact that the rubber elastic damping element is supported on the bearing surface in such a manner that it can be moved freely radially means that the spring and damping characteristic in the radial direction is determined essentially by the flat spiral spring. The pre-stressing force of the contact between the damping element and the bearing surface can be determined by design. If contact is only slight, the rubber elastic damping element is essentially ineffective in the radial direction. A predetermined higher pre-stressing force results in sliding friction by means of which the damping characteristic in the radial direction can be set in a specific manner.

In order to avoid undesired high radial deflection of the anti-vibration element which is comparably non-rigid in this direction under corresponding, particularly static, load, a stop acting in the radial direction is expediently Similarly, in the event of unexpectedly high manual forces any excessively high relative movement of the handle is thus avoided and operating accuracy is increased. The overloading of the corresponding anti-vibration element is also avoided.

In an advantageous development the rubber elastic damping element has a bead which extends in the axial direction and lies on the bearing surface, the bead being designed as a part of the stop. In a simple, cost-saving design, the bead thus performs a triple function integrated in one component. In a first function it acts in the axial direction as a rubber elastic damper. In a second function it acts in the radial direction as a sliding friction damper and in a third function it acts as an elastically damped stop.

To ensure a long service life and reliable operation throughout this service life, an interior space of the anti-vibration element which receives the flat spiral spring is expediently sealed externally. To this end a sealing lip is advantageously formed on the rubber elastic damping element. In a corresponding design, the rubber elastic damping element also assumes a fourth, sealing function with no additional components. It has been shown that particularly under dusty conditions such as during the operation of a parting-off grinder, for example, grinding dust can be deposited in the area of the flat spiral spring. In conjunction with humidity, the grinding dust deposited can harden such that a considerable, undesired hardening of the anti-vibration element takes place. With appropriate sealing, in particular by means of the aforementioned sealing lip, it is possible to reliably avoid this undesired effect.

The rubber elastic damping element is advantageously supported in the axial direction by means of a supporting disk. In particular in conjunction with an aforementioned bead, this ensures that elastic deformation takes places essentially in the area of this bead and thus in a clearly defined manner. The supporting disk avoids further deformation components which might adversely affect operating accuracy in a undesirable manner. In this arrangement, the supporting disk can also assume the function of a positive-fit fixing device for the rubber elastic damping element, this expediently being fixed between the supporting disk and the flat spiral spring. This then provides ease of fitting and removal without the need for additional components.

In an advantageous development, the anti-vibration element is designed at least approximately mirror symmetrically in relation to the plane of winding of the flat spiral spring. In this arrangement, a rubber elastic damping element is positioned in particular on either side of the flat spiral spring. This produces reliable, pre-set damping behavior in all directions even under changing load directions.

The anti-vibration element is expediently designed as an integrated, in particular essentially rotationally symmetrical component with an outer part, an inner part, the flat spiral spring positioned between them, and the rubber elastic damping element. The integrated component can be used in comparatively few, standardized designs for a multitude of applications. No special fabrications are required. Both the manufacture and the fitting of the anti-vibration elements are simplified.

In this arrangement the rubber elastic damping element is advantageously fixed to the inner part of the integrated component, the outer part having the bearing surface and where applicable a stop surface as a part of the radial stop. This guarantees reliable operation and ease of fitting.

In an advantageous embodiment the flat spiral spring is designed in particular as a flat wound leaf spring. Particularly with approximately disk-shaped rubber elastic damping elements positioned on either side, the flat winding shape produces a compact design. It also results in a precisely adjustable spring and damping characteristic in both the axial and the radial directions, it being possible to set symmetrical spring and damping behavior in particular in relation to the two axial directions.

In order to provide ease of fitting on the one hand and play-free, low-wear operation on the other hand, the flat spiral spring is advantageously held in a positive-fit and in particular in corresponding peripheral grooves between the inner part and the outer part. In this arrangement, ease of fitting can be achieved in particular by a design of the inner part in which the inner part is designed as two parts in axial direction and preferably screwed together coaxially. In this arrangement, a first part of the inner part expediently has a shank with a shoulder, a sleeve of the second part of the inner part being pushed onto the shank of the first part. Between the sleeve and the shoulder there is formed a peripheral groove in which the flat spiral spring can be fixed in a positive-fit. When designed appropriately, the leaf spring can, for example, be clamped into place in the axial direction without play due to the effect of the screwing.

### BRIEF DESCRIPTION OF THE DRAWINGS

An embodiment of the invention is described in greater detail below with reference to the drawings, in which:

FIG. 1 shows an exploded perspective view of the essential components of an anti-vibration element with a central flat spiral spring and rubber elastic damping elements positioned on either side thereof.

FIG. 2 shows a longitudinal sectional view of the arrangement illustrated in FIG. 1 when fitted.

### DESCRIPTION OF SPECIFIC EMBODIMENTS

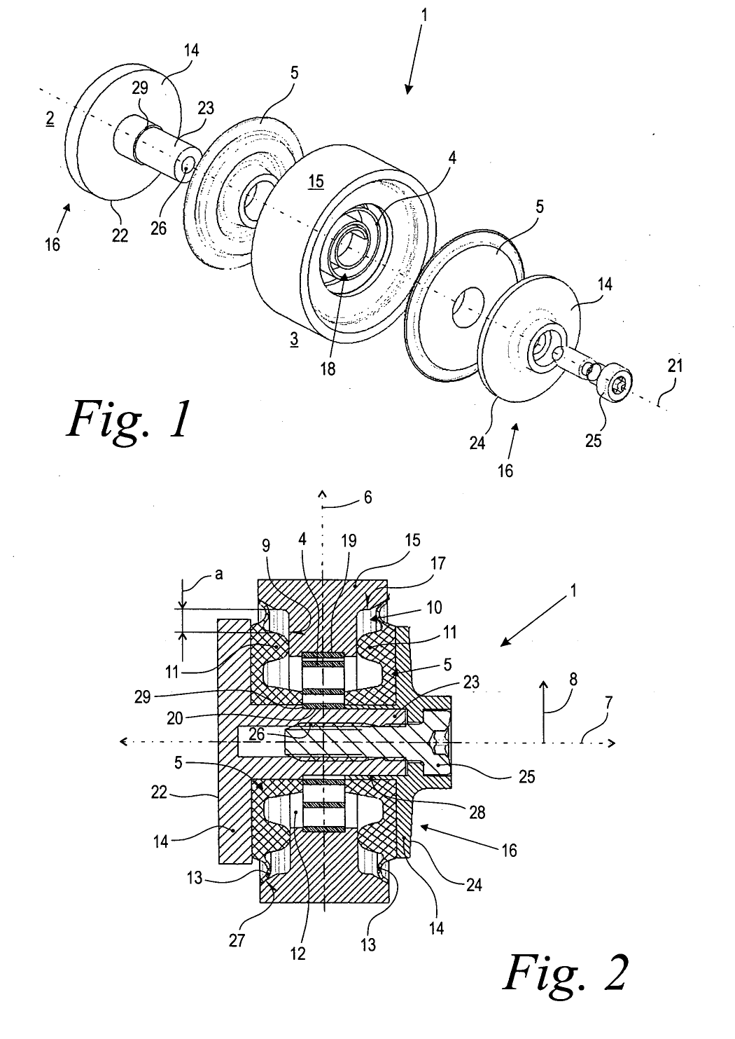

FIG. 1 shows an exploded perspective view of the essential components of an anti-vibration element 1 which is designed essentially rotationally symmetrical in relation to a longitudinal axis 21.

An inner part 16 is designed in two parts and comprises a first part 22 and a second part 24, the first part 22 and the second part 24 being separated from one another in the axial direction and it being possible to connect them by means of a coaxially positioned screw or bolt 25. The first part 22 has a supporting disk 14 which extends in the radial direction and a shank 23 which runs in axial direction towards the second part 24. The shank 23 is provided with a shoulder (29 and a central internal thread 26 to receive the screw 25.

The inner part 16 is provided for fixing to a component 2 (not illustrated in greater detail), for example a part of the engine of a parting-off grinder. An outer part 15 may be fixed to a further component 3 (not illustrated in greater detail), for example a handle of such a parting-off grinder. The anti-vibration element 1 shown may also be used in any other manually operated implement. It is also possible to provide an arrangement between two components 2, 3, for example in the form of an elastically suspended engine and a corresponding housing or similar structure.

Positioned within the annular outer part 15 is a flat spiral spring 4 which, in the embodiment shown, is designed as a wound leaf spring 18 which perpendicular to the longitudinal axis 21, is flat and spiral-shaped. It is also possible to provide a wire winding, for example with a circular cross-section and/or a conical winding form. Rubber elastic damping elements 5 are provided on either side of the flat spiral spring 4 in relation to the direction of the longitudinal axis 21. The rubber elastic damping elements 5 have approximately the shape of a circular disc-shaped plate.

When fitted or mounted, the rubber elastic damping elements 5 lie flat against the supporting disks 14 of the first and second parts 22, 24, the annular outer part 15 and the flat spiral spring 4 lying between them in the axial direction. In this arrangement, the flat spiral spring 4 is mounted elastically in all spatial directions, i.e. in both the axial and the radial directions in relation to the longitudinal axis 21.

FIG. 2 shows a longitudinal sectional view of the arrangement illustrated in FIG. 1 in the fitted or mounted position. The flat spiral spring 4 is wound in a plane of winding 6. The plane of winding 6 and the direction of the longitudinal axis 21 (FIG. 1) provide an axial direction 7 and a radial direction 8.

In this arrangement, the anti-vibration element 1 shown by way of example is designed approximately mirror symmetrically in relation to the plane of winding 6. A rubber elastic damping element 5 is positioned on either side of the flat spiral spring 4. The arrangement comprising the flat spiral spring 4 and the rubber elastic damping elements 5 can, when appropriately designed, be integrated directly between two components 2, 3 (FIG. 1). In the embodiment illustrated, the anti-vibration element is designed as a rotationally symmetrical, integrated component having the outer part 15, the inner part 16, the flat spiral spring 4 positioned between them, and the rubber elastic damping elements 5 which are also positioned between them.

The second part 24 of the inner part 16 has a sleeve 28 facing the flat spiral spring 4 which is pushed over the shank 23 of the first part 22. Between the sleeve 28 and the shoulder (29 is formed a peripheral groove 20 in which the flat spiral spring 4 is fixed in a positive-fit to the inner part 16. Here the flat spiral spring 4 is held between the shoulder (29 and the sleeve 28 under a pre-stressing force acting in the axial direction 7 as a result of the screwing of the screw 25 and the internal thread 26. The annular outer part 15 is designed as a monolithic part and also has a peripheral groove 19 around its inside into which the leaf spring 4 is elastically snapped and held in a positive-fit.

The shaft 23 passes without play through the center of the rubber elastic damping element 5 which is positioned on the side of the first part 22. The same applies to the opposite rubber elastic damping element 5 through the center of which the sleeve 28 of the second part 24 also passes without play. Both rubber elastic damping elements 5 are of identical design and are positioned mirror symmetrically in relation to one another, being held onto the inside in a positive-fit by means of a hub-like recess near to the axis between the outer supporting disks 14 and the flat spiral spring 4. In this arrangement, the rubber elastic damping elements 5 are also supported radially further outside in the axial direction 7 by means of the supporting disks 14.

The annular outer part 15 has an approximately T-shaped cross-section, the T-shaped cross-section resulting on both sides in bearing surfaces 9 running in the radial direction 8, and inwardly facing, cylindrically extending stop surfaces. The two identically designed rubber elastic damping elements 5 each have an inwardly facing, annularly extending bead 11 extending in the axial direction 7 which lie on the facing bearing surface 9 with a defined pre-stressed force. The pre-stressed force may also be set to be low or zero. Where appropriate, there may also be a small distance between the bead 11 and the bearing surface 9. The annular bead 11 is positioned a distance (a) from the stop face 17 in the radial direction 8, as a result of which the bead 11 on the rubber elastic damping element 5 is able to move essentially freely in the radial direction 8. The radial mobility is limited by the distance (a). When moved more than the distance (a), the bead 11 stops at the stop face 17 which thus forms a radially acting stop 10.

In the arrangement shown the inner part 16 and the outer part 15 can be moved in relation to one another in all spatial directions, i.e. both in the axial direction 7 and in all radial directions 8. In this arrangement, the flat spiral spring 4 which is fixed in a positive-fit on both the inner part 16 and the outer part 15 is mounted or guided elastically in all spatial directions. If the spring is deflected in the radial direction 8, the beads 11 on the rubber elastic damping elements 5 slide with little force on the corresponding bearing surfaces 9. The rubber elastic damping elements 5 thus have no or only low rigidity in the radial direction which, where present, is lower than the spring rigidity of the flat spiral spring 4 in the same direction.

In the axial direction 7, the spring rigidity of the entire system is composed of the spring rigidity of the flat spiral spring 4- and the elastic deformability of the beads 11. Here the beads 11 are designed to be more rigid in the axial direction 7 than the flat spiral spring 4 in the same direction in terms of both shape and material. This means that the rubber elastic damping elements 5 are more rigid in the axial direction 7 than in the radial direction 8.

Formed between the outer part 15 and the inner part 16 is an interior space 12 in which is positioned the flat spiral spring 4. The interior space 12 is delimited externally essentially by the T-shaped cross-section of the annular outer part 15 and by the two supporting disks 14 positioned at the ends. Formed radially on the outside of the rubber elastic damping elements 5 is a peripheral sealing lip 13 which bridges a gap between the supporting disks 14 and the outer part 15. Here the sealing lip 13 lies adjacent to an angled sealing surface 27 which runs around the inside of the outer part 15 forming a seal, thereby sealing the interior space 12 from dirt penetration from the outside.

The embodiment illustrated in FIGS. 1 and 2 represents only one possible version of the invention. Other versions of the invention may also be useful. The rubber elastic damping element 5 may, for example, also be fixed to the outer part 15. In addition to a positive-fit connection, application by means of vulcanization or spraying are also possible. Instead of the sliding contact between the bead 11 and the bearing surface 9 is it also possible to provide a fixed connection. For example, a cylindrical, tubular rubber elastic ring which is fixed both to the inner part 16 and to the outer part 15 produces lower rigidity in the radial direction than in the axial direction 7. In addition to the screwing together of the two parts 22, 24 shown for testing purposes in particular, in mass production it may also be useful to rivet or weld the two parts together or to design the inner part 16 as a monolithic part.

The designation “rubber elastic damping element 15” should be interpreted as a general term. In addition to elements made of rubber, it also includes elements made of natural or artificial materials with rubber-like spring and damping properties.

The specification incorporates by reference the disclosure of German priority document 103 35 720.3 filed 05 Aug. 2004.

The present invention is, of course, in no way restricted to the specific disclosure of the specification and drawings, but also encompasses any modifications within the scope of the appended claims.

1. An anti-vibration element for disposition between two components of a manually operated implement, comprising:
a spiral spring that is guided such that it is elastic in all spatial directions; and
a rubber elastic damping element that, relative to a plane of winding of said spiral spring, is more rigid in an axial direction than in a radial direction.

2. An anti-vibration element according to claim 1, wherein said rubber elastic damping element is more rigid in the axial direction and is less rigid in the radial direction than is said spiral spring.

3. An anti-vibration element according to claim 1, wherein said rubber elastic damping element rests against a bearing surface that extends approximately in said radial direction, whereby said rubber elastic damping element is essentially freely movable in said radial direction.

4. An anti-vibration element according to claim 3, wherein said rubber elastic damping element rests against said bearing surface under pre-stress.

5. An anti-vibration element according to claim 3, wherein a stop that acts in said radial direction is provided.

6. An anti-vibration element according to claim 5, wherein said rubber elastic damping element is provided with a bead that extends in said axial direction and rests against said bearing surface, wherein said bead is part of said stop.

7. An anti-vibration element according to claim 1, which further includes an interior space for receiving said spiral spring, wherein said interior space is sealed toward the outside.

8. An anti-vibration element according to claim 7, wherein a sealing lip is formed on said rubber elastic damping element for sealing said interior space.

9. An anti-vibration element according to claim 5, wherein a supporting disk is provided for supporting said rubber elastic damping element in said axial direction.

10. An anti-vibration element according to claim 9, wherein said rubber elastic damping element is held in a positive manner between said supporting disk and said spiral spring.

11. An anti-vibration element according to claim 1, that is at least approximately mirror symmetrical relative to a central plane, wherein a respective rubber elastic damping element is disposed on opposite sides of said spiral spring.

12. An anti-vibration element according to claim 1, which is an integrated component having an outer part, an inner part, said spiral spring, which is disposed between said outer part and said inner part, and said rubber elastic damping element.

13. An anti-vibration element according to claim 12, which is an essentially rotationally symmetrical part.

14. An anti-vibration element according to claim 12, wherein said rubber elastic damping element is secured to said inner part, and wherein said outer part is provided with a bearing surface as part of a radial stop.

15. An anti-vibration element according to claim 14, wherein said outer part is furthermore provided with a stop surface as part of said radial stop.

16. An anti-vibration element according to claim 1, wherein said spiral spring 4 is a flat wound leaf spring.

17. An anti-vibration element according to claim 12, wherein said spiral spring is positively held between said inner part and said outer part.

18. An anti-vibration element according to claim 17, wherein said spiral spring is held in corresponding peripheral grooves of said outer part and said inner part.

19. An anti-vibration element according to claim 12, wherein said inner part has a-two-part configuration in said axial direction, and wherein said two parts are in particular screwed together coaxially.

20. An anti-vibration element according to claim 19, wherein a peripheral groove is provided for receiving said spiral spring, wherein said peripheral groove is formed by a shank of a first part, said shank having a shoulder, as well as by a sleeve of a second part of said inner part, and wherein said sleeve is pushed onto said shank.
